(19) United States
(12) Patent Application Publication
(10) Pub. No.: US 2018/0336576 A1
(43) Pub. Date: Nov. 22, 2018

(54) Process of extraction of artistic talents.

(71) Applicant: Amon Rweyemamu Mtaza, Seattle, WA (US)

(72) Inventor: Amon Rweyemamu Mtaza, Seattle, WA (US)

(21) Appl. No.: 15/731,295

(22) Filed: May 19, 2017

(51) Int. Cl. G06Q 30/02; G07C 13/00; H04M 1/725

(52) U.S. Cl. CPC G06Q 30/0201; G06Q 30/0269; G06Q 30/0261; G06Q 30/0203; G07C 13/00; H04M 1/72552; G06Q 30/0267; G06Q 30/0271

(57) ABSTRACT

An improved process of discovering, refining, evaluating, separating and promoting expressive performance of artistic abilities of human beings gifted with rare artistic skills.

### FIELD OF THE INVENTION

The present invention relates generally to the process of extraction and refinement of natural resources, and more particularly to an improved process of discovering, extracting, refining, evaluating, separating, and promoting expressive performance of artisitc abilities of human beings gifted with rare artistic skills, using electronic telecommunication devices and tools.

### BACKGROUND OF PRIOR ART

The expressive performance of artistic abilities of human beings gifted with rare artistic talents that has the potential of reaching the level of artistic skills and popularity of those of stars and superstars in the music and entertainment industry are like precious metals and minerals, such as gold and diamond, which, although they can occasionally be found at close range, are more likely found deep in the ground requiring a more elaborate process to discover, extract and separate them.

It has been found that such expressive performance of artistic abilities are more likely sheltered by human beings whose life has been more of a struggle, whereby their artistic skills have been forged by their ability to surmount hardships of all sorts, which required them to reach deep within themselves to find their inner resources to continue to live their life, that is, their expressive performance of artistic abilities.

Some of these human beings gifted with such rare artistic abilities may come from higher socio-economic classes and possess the financial and human resources to develop their artistic abilities. However, a great majority of such gifted human beings also come from lower socio-economic classes and are disadvantaged with meager financial and human resources, in addition of having to fulfill their daily responsibilities. They are students who are preoccupied with their education, hoping to one day make a living from it; they are mothers and fathers who are raising their family and working 8 am to 5 pm, and who have not enough time to pursue their dream of becoming a star or superstar in the music and entertainment industry.

Even worse, other such talented human beings are further handicaped in their effort to become a star or superstar in the music and entertainment industry by being restrained by their lack of any financial and human resources and their poverty, thus having to put aside their dream.

There are already “Reality TV Talent Shows” such “American Idol” and “The Voice” that exist and provide an opportunity to gifted human being to expose their expressive performance of artistic abilities. However, these shows require that these human beings travel to distant city post to pass a live audition, requiring them to have substantial financial and human resources available to them.

However, these reality TV talent shows fail to provide an equal opportunity to those gifted human being who do not have such required financial and human resources to allow them to travel to these distant city post, and for that reason have been forgotten.

The present invention therefore intends to be an innovative improvement of the already existing process of discovering, extracting, refining, evaluating, separating, and promoting the expressive performance of artistic abilities of human beings gifted with such rare artistic talents from all socio-economic classes using electronic telecommunication devices and tools.

### OBJECTIVES AND ADVANTAGES

This improved process of discovering, extracting, refining, evaluating, separating, and promoting expressive performance of artistic abilities of human beings gifted with rare talents addresses the failure of the existing “Reality TV Talent Shows” to also reach out to those human beings gifted with rare artistic talents, but who are from lower socio-economic classes and have long been forgotten, by, in addition to provide city posts for a live audition, using electronic telecommunication devices and tools for these forgotted talented human beings to have an opportunity to expose their expressive performance of artistic abilities from the comfort of their home or a practicable location.

Therefore, the characteristic advantage of the present invention is achieved by this improved process providing a cost-effective, practical, and feasible method of obtaining expressive performance of artistic abilities from human beings from all socio-economic classes, including those of the human beings from the lower socio-economic classes that have been left untouched and which constitute a substantially rich source of highly promotable expressive performance of artistic abilities.

### SUMMARY OF THE INVENTION

The present invention is an improved process by which human beings, gifted with rare artistic talents, and from all socio-economic classes, are targeted to uncover, extract, refine, and evaluate their expressive performance of artistic abilities, and separate those which reach the level of artistic skills and popularity of those of stars and superstars in the music and entertainment industry to promote them through the music and entertainment industry.

### BRIEF DESCRIPTION OF THE DRAWINGS

The above-mentioned and other features and advantages of this invention, and the manner of attaining them, will become more apparent and the invention will be better understood by reference to the following descriptions of embodiments of the invention taken in conjunction with the accompanying drawings, wherein:

FIG. 1 is a flow diagram of the process of targeting, reaching, and discovering human beings gifted with rare artistic abilities.

FIG. 2 is a flow diagram of the process of identifying, registering, separating, and selecting human beings whose expressive performance of artistic abilities reach a specific threshold of artistic skills, and who have the financial and human resources to travel to a distant city post to pass a live audition.

FIG. 3 is a flow diagram of the process of identifying, registering, separating, and selecting human beings whose expressive performance of artistic abilities reach a specific threshold of artistic skills, and who do not have the financial and human resources to travel to a distant city post, but have access to a computer with internet and video and audio recording equipments and tools that allow them to pass a live audition from the comfort of their home or a practicable location.

FIG. 4 is a flow diagram of the process of identifying, registering, separating, and selecting human beings whose expressive performance of artistic abilities reach a specific threshold of artistic skills, and who neither have the financial and human resources to travel to a distant city post, nor have access to a computer with internet and video and audio recording equipments and tools, but to whom are provided an “Electronic Small localtity Post” nearby there home to pass a live audition.

FIG. 5 is a flow diagram of the process of identifying, registering, separating, and selecting human beings whose expressive performance of artistic abilities reach a specific threshold of artistic skills, and neither have the financial and human resources to travel to a distant city post, have access to a computer with Internet and video and audio recording equipments and tools, nor have access to an “Electronic Small Locality Post,” but only have access to a phone to pass a live audition.

FIG. 6 is a flow diagram of the process of refining and separating the human beings whose expressive performance of artistic abilities reach a higher threshold of artistic skills and popularity from those that does not.

FIG. 7 is a flow diagram of the process of refining the expressive performance of artistic abilities of the selected human beings, and of separating and selecting the human beings whose expressive performance of artistic abilities reach the level of artistic skills and popularity of those of stars and superstars in the music and entertainment industry to promote their expressive performance of artistic abilities through the music and entertainment industry.

### DETAILED DESCRIPTION OF THIS INVENTION

While the invention is susceptible to various modifications and alternative forms, the specific embodiment(s) shown and/or described herein is by way of example. It should thus be appreciated that there is no intent to limit the invention to the particular form disclosed, as the intention is to cover all modifications, equivalents, and alternatives falling within the spirit and scope of the invention as defined by the appended claims.

A process by which human beings gifted with rare artistic abilities, from all socio-economic classes, are targeted to cause them to expose their expressive performance of artistic abilities in order for it to be discovered, extracted, refined, evaluated, and separated for the purpose of obtaining expressive performances of artistic abilities that reach the level of artistic skills and popularity of those of stars and superstars in the music and entertainment industry and promote them through the music and entertainment industry.

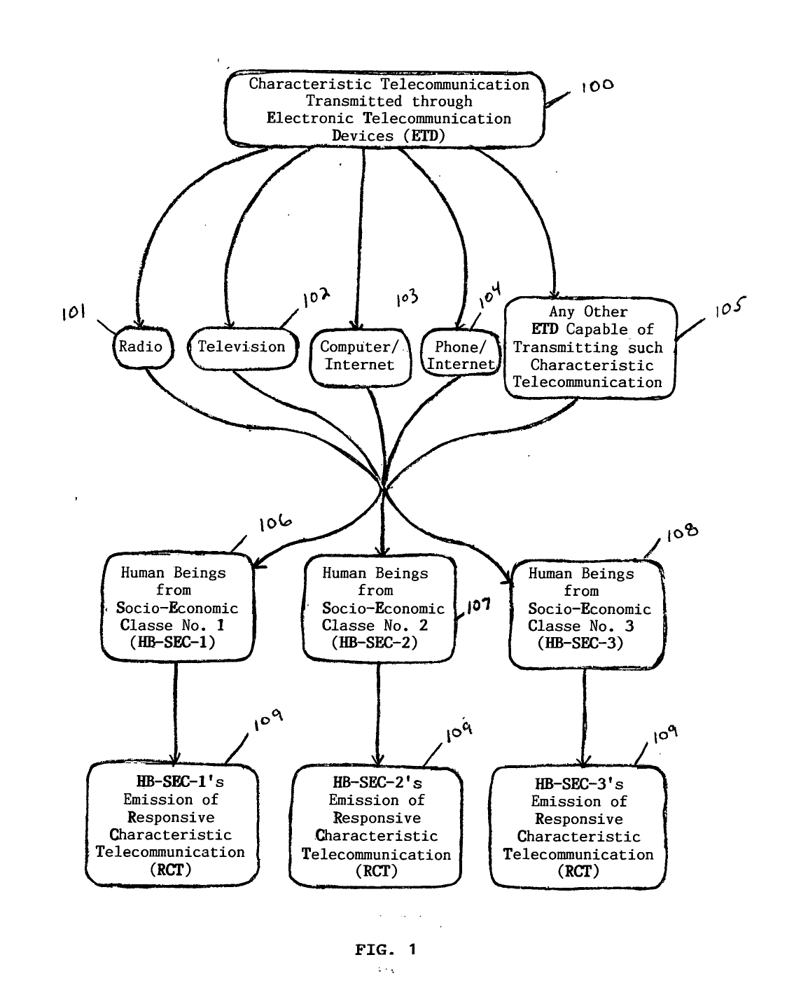

To achieve this process, and with reference to FIG. 1, a characteristic telecommunication, made of signs, signals, writings, images, and/or sounds, or made of intelligence of any nature by wire, radio, or any other electromagnetic system (box 100), transmitted through electronic telecommunication devices, such as radio (box 101), television (box 102), computer/internet (box 103), phone with internet (box 104), and/or any other electronic device capable of transmitting such characteristic telecommunication (box 105), to reach human beings from all socio-economic classes and specifically those human beings who possess rare artistic abilities from any country of the world and cause them to react by emitting a responsive characteristic telecommunication (box 109).

The targeted human beings may come from three distinct socio-economic classes: Classe No. 1 are human beings who have the financial and human resources to travel to a distant city post to pass a live audition in order to expose their expressive performance of artistic abilities (box 106); Classe No. 2 are human beings who do not have the financial and human resources to travel to a distant city post, but have access to a computer with internet and video and audio recording equipments and tools to expose their expressive performance of artistic abilities from the comfort of their home or from a practicable location (box 107); and Classe No. 3 are human beings who neither have the financial and human resources to travel to a distant city post, nor have access to a computer with internet and video and audio recording equipments and tools to expose their expressive performance of artistic abilities, but only have a phone to expose their expressive performance of artistic abilities (box 108).

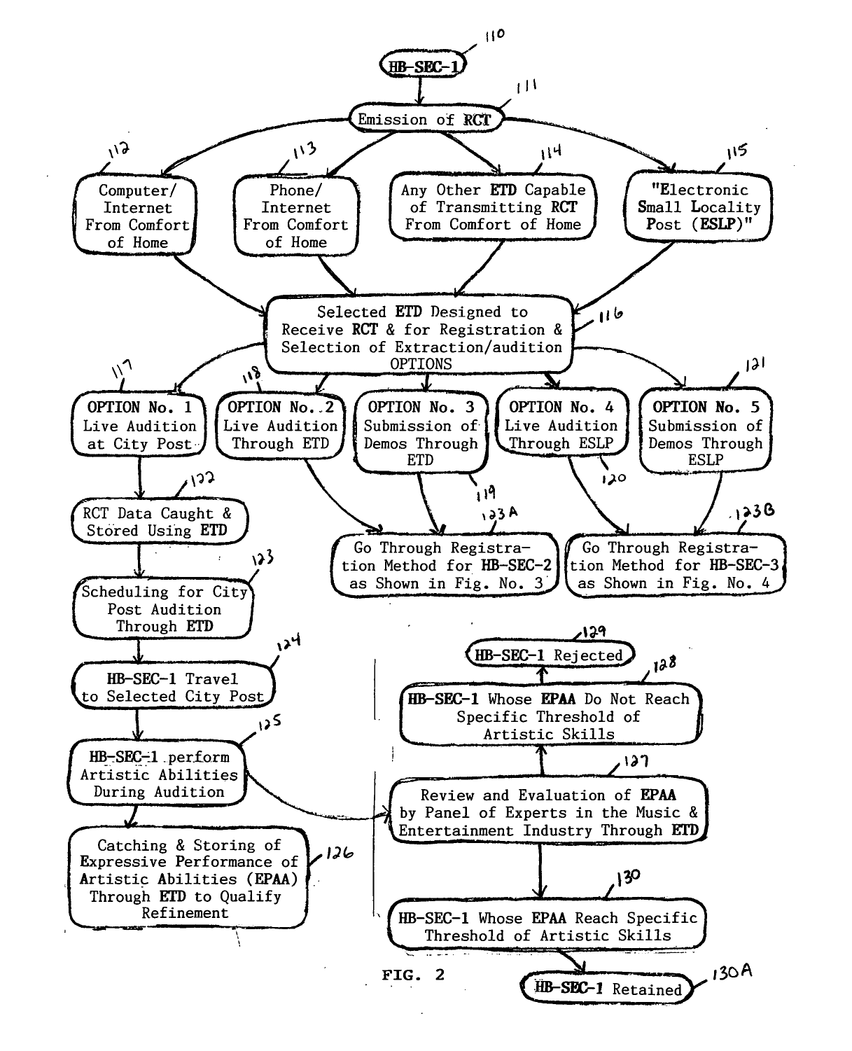

Thus, with reference to FIG. 2, the responsive characteristic telecommunication (box 111) emitted by human beings from socio-economic classe No. 1 (box 110), which is transmitted through electronic telecommunication devices, such as a computer with Internet from the comfort of their home or from a practicable location (box 112), a phone with internet from the comfort of their home or from a practicable location (box 113), any other electronic telecommunication system capable of transmitting such responsive characteristic telecommunication from the comfort of their home or from a practicable location (box 114), or an “Electronic Small Locality Post” (box 115), and received by a selected electronic telecommunication device, such as a computerized system and its electronic supportive components using internet and operating a website, providing different methods of extraction/audition of expressive performance of artistic abilities, and from which each human being is required to register by providing their personal and contact information and selecting their preferred method of extraction/audition (box 116).

The methods of extraction/audition are as follow:

(a) Option No. 1: a live audition at a city post (box 117);
(b) Option No. 2: a live audition through electronic telecommunication devices, such as a computer with internet and video and audio recording equipments and tools from the comfort of their home or from a practicable location (box 118);
(c) Option No. 3: the submission of demo(s) of expressive performance of artistic abilities through electronic telecommunication devices, such as a computer with internet from the comfort of their home or from a practicable location (box 119);
(d) Option No. 4: a live audition through an “Electronic Small Locality Post” (box 120); or
(e) Option No. 5: the submission of demo(s) of expressive performance of artistic abilities through an “Electronic Small Locality Post” (box 121).

Then the data received from the responsive characteristic telecommunication emitted by the human beings is caught, saved and stored using electronic telecommunication devices and tools, such as a computerized system and its electronic supportive components (box 122).

Upon registering, each human being may elect to choose any of the 5 extraction/audition methods, without consideration of their socio-economic status, and upon choosing the method of their choice:

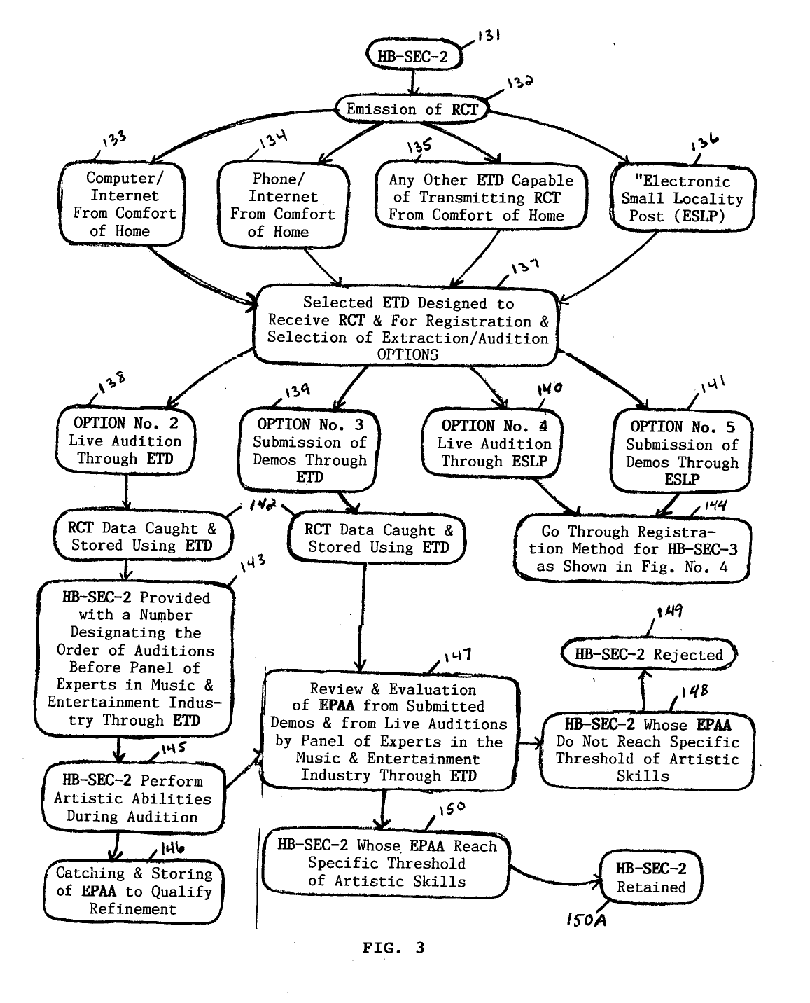

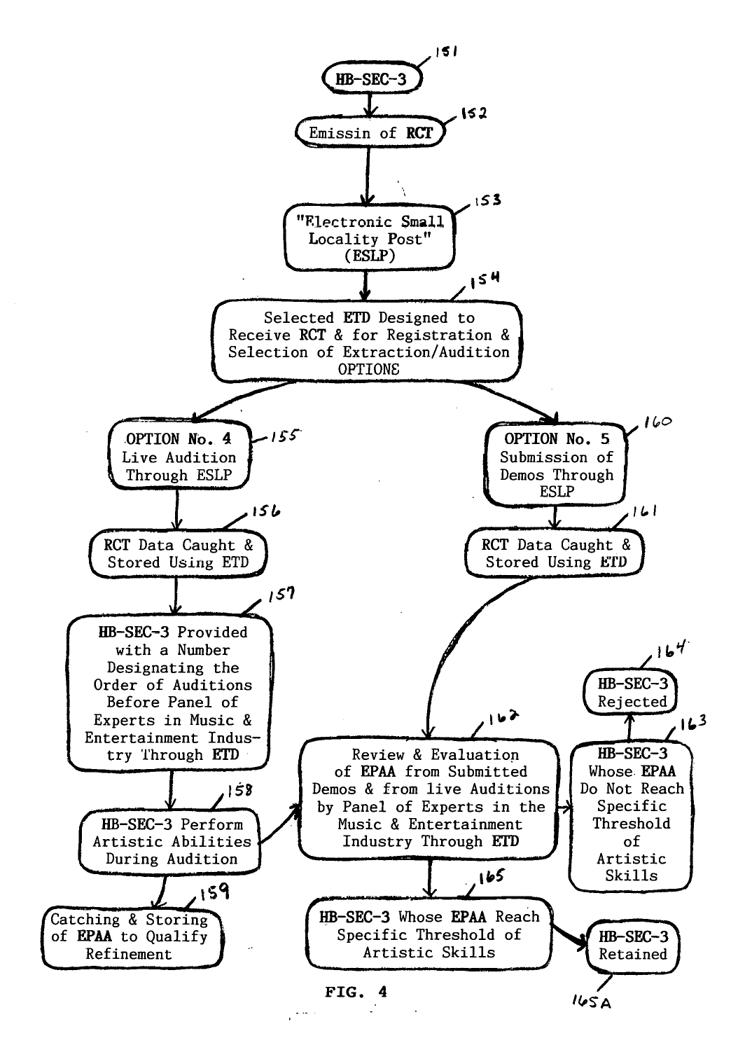

(a) when selecting Option No. 1, the human being is provided, through electronic telecommunication devices, such as a computer with internet and e-mail, with the scheduled date for his live extraction/audition and the location of the city post where he must report for the live extraction/audition of his expressive performance of artistic abilities (box 123).
(b) when selecting Option No. 2 and No. 3 the human being goes through the registration process and exposes his expressive performance of artistic abilities through the method set for human beings from socio-economic classe No. 2, as shown in FIG. 3 (box 123A).
(c) when selecting Option No. 4 and No. 5, the human beings goes through the registration process and exposes his expressive performance of artistic abilities through the method set for human beings from socio-economic classe No. 3, as shown in FIG. 4 (box 123B).

Those human beings who selected Option No. 1 then travel to the selected city post (box 124), where, during the extraction/audition, each human being performs his artistic abilities (box 125), which is reviewed and evaluated by a panel of experts in the music and entertainment industry (box 127), to determine those human beings whose expressive performance of artistic abilities does not reach a specific threshold of artistic skills (box 128) and reject them (box 129), where those whose expressive performance of artistic abilities does reach a specific threshold of artistic skills (box 130) are retained (box 130A).

The expressive performances of artistic abilities extracted from the retained human beings are caught, saved and stored using electronic telecommunication devices, such as video and audio recording equipments and tools, to qualify the refinement of later extracted expressive performance of artistic abilities (box 126).

With reference to FIG. 3, the responsive characteristic telecommunication (box 132) emitted by human beings from socio-economic classe No. 2 (box 131), and transmitted through electronic telecommunication devices, such as a computer with internet from the comfort of their home or from a practicable location (box 133), a phone with internet from the comfort of their home or from a practicable location (box 134), any other electronic telecommunication system capable of transmitting such responsive characteristic telecommunication from the comfort of their home or from a practicable location (box 135), or an “Electronic Small Locality Post” (box 136), and received by a selected electronic telecommunication devices, such as a computerized system and its electronic supportive components using Internet and operating a website, providing different methods of extraction/audition of expressive performance of artistic abilities, and from which the human beings register by providing their personal and contact information and selecting their preferred method of extraction/audition (box 137).

The methods of extraction/audition are as follow:

(a) Option No. 2: a live audition through electronic telecommunication devices, such as a computer with internet and video and audio recording equipments and tools from the comfort of their home or from a practicable location (box 138);
(b) Option No. 3: the submission of demo(s) of expressive performance of artistic abilities through electronic telecommunication, such as a computer with internet, from the comfort of their home or from a practicable location (box 139);
(c) Option No. 4: a live audition through an “Electronic Small Locality Post” (box 140); or
(d) Option No. 5: the submission of demo(s) of expressive performance of artistic abilities through an “Electronic Small locality Post” (box 141).

Then the data received from the responsive characteristic telecommunication emitted by the human beings is caught, saved and stored using electronic telecommunication devices and tools, such as a computerized system and its electronic supportive components (box 142).

Upon registering, each human being may elect to choose any of the 4 extraction/audition methods, without consideration of their socio-economic status, and upon choosing the method of their choice:

(a) when selecting Option No. 2, the human being is provided with a number designating the order that the live auditions will be held, where each human being waits for his number to come up to perform his artistic abilities live before a panel of experts in the music and entertainment industry through electronic telecommunication devices (box 143).
(b) when selecting Option No. 3, the human being's demo(s) of expressive performance of artistic abilities is later reviewed and evaluated by a panel of experts in the music and entertainment industry through electronic telecommunication devices, whereafter the experts notify each human being of their decision through electronic telecommunication devices, such as computer with internet and e-mail (box 147, 148, 149, 150, and 150A).
(c) when selecting Option No. 4 and No. 5, the human being goes through the registration process and exposes his expressive performance of artistic abilities through the method set for human beings from socio-economic classe No. 3, as shown in FIG. 4 (box 144).

when the designated number of a human being, who selected Option No. 2 comes up, from the comfort of his home or from a practicable location, and through electronic telecommunication devices, such as a computer with internet and video and audio recording equipments and tools, the human being perform his artistic abilities before a panel of experts in the music and entertainment industry (box 145), who reviews and evaluates his expressive performance of artistic abilities (box 147), to determine if it reaches a specific threshold of artistic skills (box 148 and 150), and reject him if it doesn't (box 149), or retain him if his expressive performance of artistic abilities does reach such threshold (box 150A).

The expressive performances of artistic abilities extracted from the retained human beings are caught, saved and stored using electronic telecommunication devices, such as video and audio recording equipments and tools, to qualify the refinement of later extracted expressive performance of artistic abilities (box 146).

With reference to FIG. 4, an “Electronic Small Locality Post” is set up and provided, at strategic locations where access to computer, internet, and video and audio recording equipments and tools are unavailable (box 153) to human beings from socio-economic classe No. 3 (box 151), in order for them to emit and transmit their responsive characteristic telecommunication (box 152), to be received by a selected electronic telecommunication device, such as a computerized system and its electronic supportive components using internet and operating a website, providing different methods of extraction/audition to expose their expressive performance of artistic abilities, and from which these human beings register by providing their personal and contact information and selecting their preferred method of extraction/audition (box 154).

The methods of extraction/audition are as follow:

(a) Option No. 4: a live audition through an “Electronic Small Locality Post” (box 155); or
(b) Option No. 5: the submission of demo(s) through an “Electronic Small Locality Post” (box 160).

Then the data received from the responsive characteristic telecommunication emitted by the human beings is caught, saved and stored using electronic telecommunication devices, such as a computerized system and its electronic supportive components (box 156 and 161).

Upon registering, each human being may elect to choose any of the 2 extraction/audition methods, and upon choosing the method of their choice:

(a) when selecting Option No. 4, the human being is provided with a number designating the order that the live auditions will be held, where each human being waits for his number to come up to perform his artistic abilities live before a panel of experts in the music and entertainment industry through electronic telecommunication devices (box 157).
(b) when selecting Option No. 5, the human being's demo(s) of expressive performance of artistic abilities is later reviewed and evaluated by a panel of experts in the music and entertainment industry through electronic telecommunication devices, whereafter the experts notify each human being of their decision through electronic telecommunication devices, such as a computer with Internet and e-mail (box 162, 163, 164, 165, and 165A).

When the designated number of a human being, who selected Option No. 4 comes up, through the “Electronic Small Locality Post,” the human being performs his expressive performance of artistic abilities before a panel of experts in the music and entertainment industry (box 158), who reviews and evaluates his expressive performance of artistic abilities (box 162), to determine if it reaches a specific threshold of artistic skills (box 163 and 165) and reject him if it doesn't (box 164), or retain him if it does reach such threshold (box 165A).

The expressive performances of artistic abilities extracted from the retained human beings are caught, saved and stored using electronic telecommunication devices, such as video and audio recording equipments and tools, to qualify the refinement of later extracted expressive performance of artistic abilities (box 159).

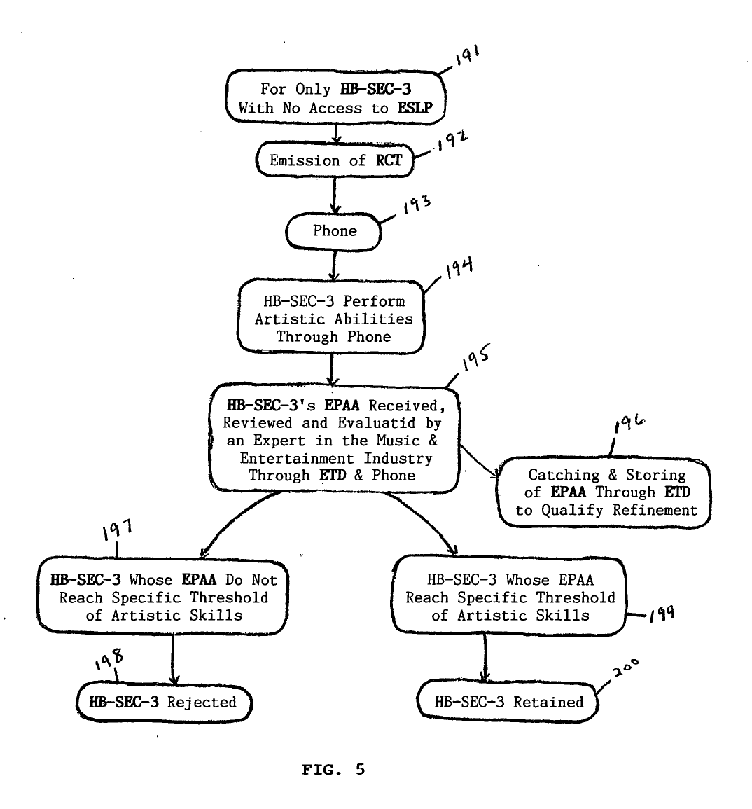

With reference to FIG. 5, the responsive characteristic telecommunication (box 192) emitted by human beings from socio-economic classe No. 3, specifically those who are isolated in localities where they do not have access to an “Electronic Small Locality post” (box 191), is transmitted through electronic telecommunication devices, such as a phone (box 193), and received by an expert in the music and entertainment industry through electronic telecommunication devices, such as a computerized system and its electronic supportive components capable of receiving such telephonic calls from a human being, and through which, at the time of the call is received by the expert, the human being performs his artistic abilities (box 194), which is immediately reviewed and evaluated by the expert (box 195), to determine if it reaches a specific threshold of artistic skills (box 197 and 199), and reject him if it doesn't (box 198), or retain him if if does reach such threshold (box 200).

The expressive performances of artistic abilities extracted from the retained human beings are caught, saved and stored using electronic telecommunication devices, such as video and audio recording equipments and tools, to qualify the refinement of later extracted expressive performance of artistic abilities (box 196).

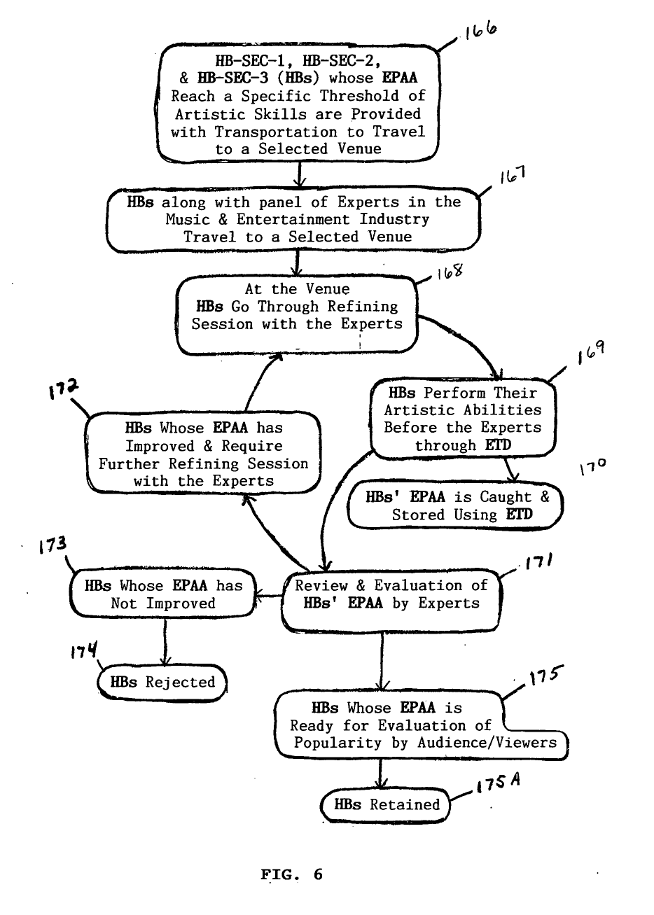

With reference to FIG. 6, the retained human beings, whose expressive performance of artistic abilities reached a specific threshold of artistic skills (box 166), along with the experts in the music and entertainment industry, travel to a selected venue (box 167).

Once at the venue, the said experts assist these human beings in improving their artistic abilities in order for them to yield more refined expressive performances of artistic abilities (box 168), where the expressive performance of artistic abilities of each human being (box 169) is caught, saved and stores using electronic telecommunication devices, such as video and audio recording equipments and tools (box 170).

From these performances of artistic abilities, the panel of experts reviews and evaluates each expressive performance of artistic abilities to determine which ones of the human beings have yielded an improved and more refined expressive performance of artistic abilities (box 171).

The human beings whose expressive performance of artistic abilities has not sufficiently improved from the refining sessions with the experts and does not reach a higher threshold of artistic skills (box 173) are rejected (box 174), where those whose expressive performance of artistic abilities has sufficiently improved from the refining sessions with the experts (box 172) continue to go through a plurality of refining sessions with the experts (box 168), and to perform their artistic abilities (box 169), which is reviewed and evaluated by the panel of experts (box 171), until the panel of experts determine which ones of the human beings are ready for the final evaluation of popularity by an audience and viewers (box 175) and retain them (box 175A).

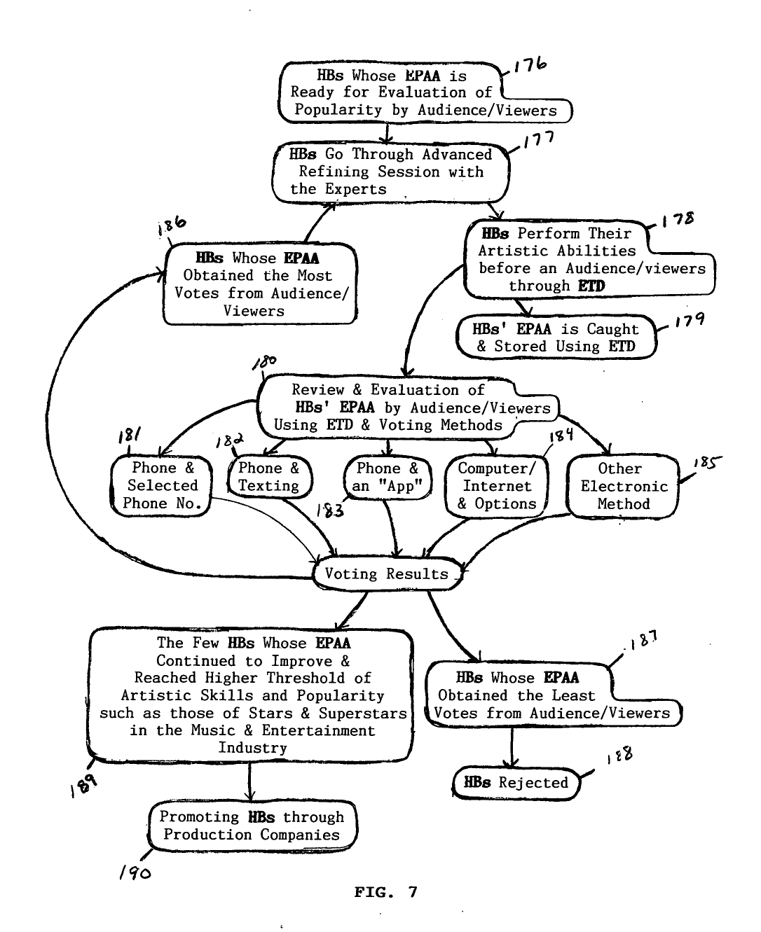

With reference to FIG. 7, the retained human beings, who are determined to be ready by the experts in the music and entertainment industry for the final evaluation of popularity by an audience and viewers (box 176), continue to go through a plurality of advanced refining sessions (box 177).

Through electronic telecommunication devices, such as electronic equipments and tools used in television production studio, the human beings perform their artistic abilities before an audience and viewers (box 178), where the extracted expressive performance of artistic abilities are caught, saved and stored using electronic telecommunication devices, such as video and audio recording equipments and tools, to qualify the refinement of later extracted expressive performance of artistic abilities (box 179).

From the review and evaluation of the extracted expressive performance of artistic abilities, the audience and viewers vote for the best performance or artistic abilities to determine its level of artistic skills and popularity (box 180), by communicating their votes through electronic telecommunication devices, such as a phone using preselected phone numbers associated to the performers (box 181), a phone using text messages and preselected numbers associated to the performers (box 182), a phone using internet and an “App” and preselected options associated to the performers (box 183), a computer with internet and preselected options associated to the performers (box 184), or any other electronic system capable of communicating the votes from the audience and viewers (box 185).

Those human beings whose expressive performance of artistic abilities obtained the least votes from the audience and viewers (box 187) are rejected (box 188), where those whose expressive artistic abilities obtained the most votes from the audience and viewers (box 186) are retained to continue to go through the advanced refining sessions with the experts (box 177), performance of their artistic abilities (box 178), and review and evaluation of their extracted expressive performance of artistic abilities by the audience and viewers through the voting methods (box 180, 181, 182, 183, 184, and 185), until the audience and viewers ultimately determine the few human beings whose expressive performance of artistic abilities has improved and reached the level of artistic skills and popularity of those of stars and superstars in the music and entertainment industry (box 189).

The few ultimate human beings are then brought to production companies for the promotion of their expressive performance of artistic abilities (box 190).

### PREFERRED EMBODIMENT OF THE INVENTION

It should be understood that the above description of the process of discovering, extracting, refining, evaluating, separating, and promoting the expressive performance of artistic abilities of human beings gifted with rare talents is exemplary of an implementation of the said process. Therefore, it should be appreciated that other implementation or modifications, equivalents, and alternatives of the said process, which are falling within the spirit and scope of the invention as defined by the appended claims, are possible. The following implementation of a preferred embodiment of the said process is therefore described as an example. This could be accomplished as follow:

Through radio and television medias, or through any other capable electronic media, a characteristic telecommunication in the form of a public announcement of a competition in the domain of artistic abilities that is held through a “Reality TV Talent Show” is transmitted to reach and cause human beings gifted with rare artistic abilities, from all socio-economic classes, to register to have their expressive performance of artistic abilities extracted, reviewed and evaluated by experts in the music and entertainment industry through 6 different extraction/audition method options.

Option No. 1: From the comfort of their home or from a practicable location, the targeted human beings gifted with rare artistic abilities, and who possesses the financial and human resources to travel to a distant city post to have their expressive performance of artistic abilities extracted through a live audition before a panel of experts in the music and entertainment industry, register through the “Reality TV Talent Show” website in order for them to receive the scheduled date for their live audition and the location of the city post where they must report to pass their live audition, where, at which time, the panel of experts reviews and evaluates their expressive performance of artistic abilities in order to retain those human beings whose expressive performance of artistic abilities reaches a specific threshold of artistic skills.

Option No. 2: From the comfort of their home or from a practicable location, the targeted human beings gifted with rare artistic abilities, and who do not possess the financial and human resources to travel to a distant city post, but have access to a computer with internet and video and audio recording equipments and tools, register through the “Reality TV Talent Show” website, from which these human beings are provided with a number designating the order that the extraction of their expressive performance of artistic abilities through a live audition is to be held, where these human beings wait for their number to come up to perform their expressive performance of artistic abilities from the comfort of their home or from a practicable location through a computer with internet and video and audio recording equipments and tools.

From a studio equipped with computerized system, its electronic supportive components, and video and audio recording equipments and tools, and through the “Reality TV Talent Show” website, a panel of experts in the music and entertainment industry reviews and evaluates these human beings' expressive performance of artistic abilities in order to retain those whose expressive performance of artistic abilities reaches a specific threshold of artistic skills.

Option No. 3: From the comfort of their home or from a practicable location, the targeted human beings gifted with rare artistic abilities, and who neither has the financial and human resources to travel to a distant city post, nor have the required video and audio recording equipments and tools to perform their artistic abilities live through the internet, but still have access to a computer with internet, register and submit their demo(s) of their expressive performance of artistic abilities through the “Reality TV Talent Show” website, from which demo(s), a panel of experts in the music and entertainment industry reviews and evaluates the expressive performance of artistic abilities in order to retain those human beings whose expressive performance of artistic abilities reaches a specific threshold of artistic skills.

Option No. 4: Through an “Electronic Small Locality Post,” which has been set up at different localities and provided for those targeted human beings gifted with rare artistic abilities, who neither have the financial and human resources to travel to a distant city post, nor have access to a computer with Internet and video and audio recording equipments and tools, register through the “Reality TV talent Show” website, from which these human beings are provided with a number designating the order that the extraction of their expressive performance of artistic abilities through a live audition is to be held, where these human beings wait for their number to come up to perform their expressive performance of artistic abilities through the “Electronic Small Localities Post.”

From a studio equipped with computerized system, its electronic supportive components, and video and audio recording equipments and tools, and through the “Reality TV Talent Show” website, a panel of experts in the music and entertainment industry reviews and evaluates these human beings' expressive performance of artistic abilities in order to retain those human beings whose expressive performance of artistic abilities reaches a specific threshold of artistic skills.

Option No. 5: Through an “Electronic Small Locality Post,” which has been set up at different localities and provided for the targeted human beings gifted with rare artistic abilities, and who neither have the financial and human resources to travel to a distant city post, nor have access to a computer with internet and video and audio recording equipments and tools, register and submit their demo(s) of their expressive performance of artistic abilities through the “Reality TV Talent Show” website, from which demo(s) a panel of experts in the music and entertainment industry reviews and evaluates the expressive performance of artistic abilities in order to retain those human beings whose expressive performance of artistic abilities reaches a specific threshold of artistic skills.

Option No. 6: Through the use of a phone, or any other electronic telecommunication device capable of communicating a telephonic call, the targeted human beings gifted with rare artistic abilities, and who have neither the financial and human resources to travel to a distant city post, nor have access to a computer with internet and/or video and audio recording equipments and tools, nor have access to an “Electronic Small Locality Post,” register and connect with a live expert in the music and entertainment industry, who from a studio equipped with computerized system, its electronic supportive components, and video and audio recording equipments and tools, capable of receiving telephonic calls from these human beings, reviews and evaluates the expressive performance of artistic abilities of these human beings performed live over the phone, in order to retain those human beings whose expressive performance of artistic abilities reaches a specific threshold of artistic skills.

Human beings gifted with rare artistic abilities may elect to register and have their expressive performance of artistic abilities extracted through any of the 6 extraction method options, without any consideration made concerning their socio-economic status.

During this registration, extraction, review and evaluation process, the expressive performances of artistic abilities extracted from these human beings are caught, saved and stored using video and audio recording equipments and tools for the purpose of qualifying the refinement of later extracted expressive performance of artistic abilities.

All the human beings retained by the experts in the music and entertainment industry are provided with transportation to travel to a preselected venue to participate in the competition of artistic abilities through the “Reality TV Talent Show.”

At the venue, where the panel of experts in the music and entertainment industry have traveled to as well, the experts provide refining sessions to the retained human beings to assist them in improving their artistic skills in order to yield a more refined expressive performance of artistic abilities.

The first week or plurality of week of the “Reality TV Talent Show,” each retained human beings performs their artistic abilities live on television, radio, internet, or any other media means capable of transmitting such live performance to an audience and viewers. During that or these weeks, the panel of experts reviews and evaluates each expressive performance of artistic abilities in order to determine those human beings whose expressive performance of artistic abilities has most improved from the refining sessions and yielded a higher threshold of artistic skills.

The threshold of artistic skills set to evaluate the refinement of the retained human beings' expressive performance of artistic abilities is determined by the experts and based on different factors, which are; but not limited to, (1) the discretion of the experts; (2) the level of artistic skills of the retained human beings; and (3) the number of human beings's performances the producer of the show determines feasible to cast during the programation.

The expressive performances of artistic abilities extracted during each show are caught, saved and stored using video and audio recording equipments and tools in order to further qualify the refinement of later extracted expressive performance of artistic abilities.

Based on the review and evaluation of the extracted expressive performance of artistic abilities of the retained human beings from each show, the experts determine those human beings whose expressive performance of artistic abilities has persistently improved from the refining sessions with the experts and yielded a higher threshold of artistic skills set by the experts.

The human beings whose expressive performance of artistic abilities has not sufficiently improved and yielded a higher threshold of artistic skills are rejected, where those whose expressive performance of artistic abilities does have improved from the refining sessions with the experts and yielded a higher threshold of artistic skills are further retained to continue the refining process through the “Reality TV talent Show.”

Depending on the discretion of the experts and on the theme of a specific “Reality TV Talent Show,” and until the experts determine that the human beings who have been retained in the show to further go through the refining process are ready to have their expressive performance of artistic abilities evaluate for its popularity by an audience and viewers, during their next performances, where each show, more human beings whose expressive performance of artistic abilities has not sufficiently improved and yielded a higher threshold of artistic skills are rejected from the show, where the others are retained to pursue more refining sessions with the experts and perform on the show.

Once the experts have determined which human beings are ready for their expressive performance of artistic abilities to be evaluated by an audience and viewers for their level of popularity, the experts assist the retained human beings with advance refining sessions in order to perfect their artistic skills in order to yield an even more refined expressive performance of artistic abilities for the audience and viewers to vote on its popularity.

Each following week of the show, each human beings performs his artistic abilities for the audience and viewers to vote on its popularity, where each expressive performance of artistic abilities is caught, saved and stored using video and audio recording equipments and tools, in order to qualify the refinement of later extracted expressive performance of artistic abilities from each retained human beings.

After all the retained human beings have performed their artistic abilities during a show, the audience and viewers vote for the best performance of their choice through either (1) a phone using preselected phone numbers assigned to the performers; (2) a phone using text messages and preselected number assigned to the performers; (3) a phone with internet and using an “App” and preselected options assigned to the performers; (4) a computer with internet through the “Reality TV Talent Show” website and preselected options assigned to the performers; or (6) a combination of the above voting methods.

Base on the voting result from the audience and viewers' votes, the retained human beings whose expressive performance of artistic abilities obtained the least votes are rejected from the show, where those whose expressive performance of artistic abilities obtained the most votes are retained to further go through advanced refining sessions in order to further yield more refined and popular expressive performance of artistic abilities.

The retained human beings go through further rounds of refining sessions, performance of their artistic abilities, and review and evaluation of popularity by the audience and viewers, until the audience and viewers ultimately determine by voting the few human beings whose expressive performance of artistic abilities has reached the level of artistic skills and popularity of those of stars and superstars in the music and entertainment industry.

Thus, these few human beings whose expressive performance of artistic abilities have been determined by the experts and the audience and viewers to have reached the level of artistic skills and popularity of those of stars and superstars in the music and entertainment industry are brought to production companies to further extract their expressive performance of artistic abilities in order to promote them to the public.

### ADDITIONAL EMBODIMENTS

The reader should also appreciate that this process of discovering, extracting, refining, evaluating, separating, and promoting expressive performance of artistic abilities of human beings gifted with rare artistic talents in order to yield expressive performances of artistic abilities that reaches the level of artistic skills of those of stars and superstars in the music and entertainment industry, is not limited to the extraction of expressive performance of artistic abilities of a single human being, but also includes the extraction of expressive performance of artistic abilities of a plurality of human beings combined.

Other methods of transmitting a characteristic telecommunication, of receiving responsive characteristic telecommunication emitted by human beings gifted with rare artistic abilities, of extracting their expressive performance of artistic abilities, of catching, saving and storing the extracted expressive performances of artistic abilities, and of voting for the expressive performances that yield the best artistic skills and most popularity, using electronic telecommunication devices are possible. Thus, this invention includes any other method now existing and later developed to achieve the spirit and scope of this invention, which falls within the appended claims.

The frequency and duration of a particular reality TV talent show, the number of retained human beings gifted with artistic abilities participating in a particular show, the number of expert reviewing and evaluating the extracted expressive performance of artistic abilities, the number of show that the expert(s) review and evaluate to determine which ones of the human beings are to be retained, the number of show that the audience votes to determine which ones of the human beings are to be retained, the number of human beings retained and rejected, and the number of human beings ultimately retained to have their expressive performance of artistic abilities promoted through production companies, may vary according to the theme of a particular show and the discretion of the producer of the show.

In a particular “Reality TV Talent Show” and during the evaluation of popularity of expressive performance of artistic abilities of the retained human beings, in addition to vote for the best performance, the audience may also vote to pick one or a plurality of existing art that the retained human beings are required to perform.

In a particular “Reality TV Talent Show” and during the evaluation of popularity of expressive performance of artistic abilities of the retained human beings, one or a plurality of the retained human being may be required to team up with one or a plurality of expert in the music and entertainment industry to perform their artistic abilities.

### CONCLUSION, RAMIFICATION, AND SCOPE

Thus the reader will realize that while existing “Reality TV Talent Shows” such as “American Idol” and “The Voice” have only uncovered the expressive performance of artistic abilities of human beings gifted with artistic abilities, who had the financial and human resources to travel to a distant city post to expose their artistic talents, this invention uses a more elaborated process by using electronic telecommunication means to uncover the expressive performance of artistic abilities of human beings from all socio-economic classes, which include all other human beings, who do not have the financial and human resources to travel to a distant city post to have their expressive performance of artistic abilities exposed, extracted, refined, evaluated, separated, and promoted.

It should be appreciated that the various aspects of the present invention have herein been described separately. The various aspects, however, may be combined in many manner.

While the above description contains many specificities, these should not be construed as limitations on the scope of the invention, but rather as exemplification of one preferred embodiment thereof. Accordingly, the scope of the invention should be determined by the interpretation of the appended claims in conjunction with the embodiment(s) illustrated herein.

What I claim is:

1. A process of discovering, extracting, refining, evaluating, separating, and promoting expressive performance of artistic abilities of human beings gifted with artistic abilities.

2. The process in claim 1, wherein a characteristic telecommunication in the form of a public announcement is transmitted using and through electronic telecommunication means, such as radio, television, computer with internet, phone-with internet, and/or any other electronic and/or electromagnetic system capable of transmitting such a characteristic telecommunication, now existing and later developed, for the purpose of reaching human beings gifted with artistic abilities.

3. The process in claim 2, wherein the characteristic telecommunication is formatted, articulated and transmitted through electronic telecommunication means to target human beings gifted with artistic abilities from all socio-economic classes and from one or a plurality of selected country.

4. The process in claim 3, wherein the characteristic telecommunication is formatted and articulated to trigger human beings gifted with artistic abilities to emit a responsive characteristic telecommunication comprising personal and contact information, and the selection of their preferred method of extraction of their expressive performance of artistic abilities.

5. The process in claim 4, wherein the targeted human beings emit and transmit their responsive characteristic telecommunication using and through any electronic telecommunication means, now existing and later developed, such as a phone, a phone with internet, a computer with internet, and/or any other electronic telecommunication means available to them.

6. The process in claim 5, wherein the responsive characteristic telecommunication transmitted using and through electronic telecommunication means is received by and through an electronic telecommunication means, now existing and later developed, such as a computerized system, its electronic supportive components, and video and audio recording equipments and tools.

7. The process in claim 6, wherein the responsive characteristic telecommunication comprising personal and contact information, and the selection of a preferred method of extraction of their expressive performance of artistic abilities is captured, saved and stored using and through an electronic telecommunication means, now existing and later developed, such as a computerized system, its electronic supportive components, and video and audio recording equipments and tools.

8. The process in claim 7, wherein the expressive performance of artistic abilities of human beings gifted with artistic abilities is extracted by the human beings traveling to a city post where they perform their artistic abilities live before one or a plurality of experts in the music and entertainment industry.

9. The process in claim 7, wherein the expressive performance of artistic abilities of human beings gifted with artistic abilities is extracted by the human beings performing their expressive performance of artistic abilities live before one or a plurality of experts in the music and entertainment industry from their home or from a practicable location using and through an electronic telecommunication means, now existing and later developed, such as a computer with internet, and video and audio recording equipments and tools.

10. The process in claim 7, wherein the expressive performance of artistic abilities of human beings gifted with artistic abilities is extracted by the human beings performing their expressive performance of artistic abilities, recording, saving and storing it on, in, into, a portable data storage devices, now existing and later developed, such as a compact disk, a USB flash drive, and transmitting it to one or a plurality of expert in the music and entertainment industry using and through an electronic telecommunication means, now existing and later developed, such as a computer with Internet, and/or any other means capable of transmitting such data.

11. The process in claim 7, wherein the expressive performance of artistic abilities of human beings gifted with artistic abilities is extracted by the human beings performing their expressive performance of artistic abilities live before one or a plurality of expert in the music and entertainment industry using and through an “Electronic Small Locality Post.”

12. The process in claim 7, wherein the expressive performance of artistic abilities of human beings gifted with artistic abilities is extracted by the human beings performing their expressive performance of artistic abilities, recording, saving and storing it on, in, into a portable data storage device, now existing and later developed, such as a compact disk, a USB flash drive, and transmitting it to one or a plurality of expert in the music and entertainment industry using and through an “Electronic Small Locality Post.”

13. The process in claims 11 and 12.

14. The process in claim 13, wherein the “Electronic Small Locality Post” comprises an electronic telecommunication means, now existing and later developed, such as a computerized system, its electronic supportive components, and video and audio recording equipments and tools capable of transmitting the data of live and recorded expressive performance of artistic abilities from human beings, and placed, set up, and/or provided at different small localities, where access to any other electronic telecommunication means is unavailable.

15. The process in claim 7, wherein the expressive performance of artistic abilities of human beings gifted with artistic abilities is extracted by the human beings performing their expressive performance of artistic abilities live before one or a plurality of expert in the music and entertainment industry using and through a phone.

16. The process in claims 9, 10, 11, 12, and 15.

17. The process in claim 16, wherein the extracted expressive performances of artistic abilities transmitted by the human beings are received by one or a plurality of expert in the music and entertainment industry using and through an electronic telecommunication means, now existing and late developed, such as a computerized system, its electronic supportive components, and video and audio recording equipments and tools.

18. The process in claims 8, 9, 10, 11, 12, and 15.

19. The process in claim 18, wherein the expressive performance of artistic abilities of human beings gifted with artistic abilities are reviewed and evaluated by one or a plurality of expert in the music and entertainment industry to separate and retain the human beings whose expressive performance of artistic abilities reached a specific threshold of artistic skills.

20. The process in claim 19, wherein the expressive performances of artistic abilities of human beings gifted with artistic abilities are captured, saved and stored using and through an electronic telecommunication means, now existing and later developed, such as a computerized system, its electronic supportive components, and video and audio recording equipments and tools.

21. The process in claim 20, wherein the retained human beings are transported to one or a plurality of selected venue, located in one or a plurality of different country.

22. The process in claim 21, wherein, with the assistance of one or a plurality of expert in the music and entertainment industry, the retained human beings go through one or a plurality of refining session.

23. The process in claim 22, wherein, using and through electronic telecommunication means, now existing and later developed, such as video and audio recording equipments and tools, casting equipments and tools, television networks, radio networks, internet networks, and/or any other electronic or electromagnetic system capable of transmitting the expressive performance of artistic abilities extracted from human beings to an audience and viewers, the human beings perform their expressive performance of artistic abilities live before the audience and viewers.

24. The process in claim 23, wherein, for each live performance before the audience and viewers, the extracted expressive performance of artistic abilities from each human being is captured, saved and stored using electronic telecommunication means, now existing and later developed, such as a computerized system, its electronic supportive components, and video and audio recording equipments and tools.

25. The process in claim 24, wherein, after each live performance before the audience and viewers, and for one or a plurality of performance by the retained human beings, one or a plurality of expert in the music and entertainment industry review and evaluate the extracted expressive performance of artistic abilities of the retained human beings and determine which ones of the human beings are to be retained for having yielded an expressive performance of artistic abilities that reached the highest threshold of artistic skills, and which ones of the human beings are to be rejected for having yielded an expressive performance of artistic abilities that reached the lowest threshold of artistic skills.

26. The process in claim 25, wherein after each live performance before the audience and viewers, and for one or a plurality of performance by the retained human beings, and based on the performance of artistic abilities of each human beings, the audience and viewers vote for the best expressive performance of artistic abilities.

27. The process in claim 26, wherein after each live performance of artistic abilities by the human beings before the audience and viewers, the audience and viewers transmit their individual vote using and through a phone by calling a preselected phone number designating a specific human beings.

28. The process in claim 26, wherein after each live performance of artistic abilities by the human beings before the audience and viewers, the audience and viewers transmit their individual vote using and through a phone using text messaging by texting a number designating a specific human being.

29. The process in claim 26, wherein after each live performance of artistic abilities by the human beings before the audience and viewers, the audience and viewers transmit their individual vote using and through a phone with Internet and using an “App” by selecting a preselected option designating a specific human being.

30. The process in claim 26, wherein after each live performance of artistic abilities by the human beings before the audience and viewers, the audience and viewers transmit their individual vote using and through a computer with internet by selecting a preselected option designating a specific human being.

31. the process in claim 26, wherein after each live performance of artistic abilities by the human beings before the audience and viewers, the audience and viewers transmit their individual vote using and through any other electronic telecommunication means, now existing and later developed.

32. The process in claims 27, 28, 29, 30 and 31.

33. The process in claim 32, wherein after each live performance of artistic abilities by the human beings before the audience and viewers, all votes transmitted by the audience and viewers are received, compiled, saved and stored using and through an electronic telecommunication means, now existing and later developed, such as a computerized system and its electronic supportive components.

34. The process in claim 33, wherein after each live performance of artistic abilities by the human beings before the audience and viewers, and/or before the following live performance of artistic abilities by the retained human beings before the audience and viewers, one or a plurality of human beings whose expressive performance of artistic abilities obtained the most votes from the audience and viewers are retained, and one or a plurality of human beings whose expressive performance of artistic abilities obtained the least votes from the audience and viewers are rejected.

35. The process in claim 34, where the expressive performance of artistic abilities of the few human beings retained after a plurality of session of refinement, of live performance before the audience and viewers, of review and evaluation of artistic skills and popularity by the experts in the music and entertainment industry and by the audience and viewers, and of the process of separation, is ultimately promoted through production companies to be exposed to the public.
